(19) United States
(12) Patent Application Publication
(10) Pub. No.: US 2014/0304945 A1
(43) Pub. Date: Oct. 16, 2014

(54) ATTACHING STRUCTURE FOR DOOR OF WORKING VEHICLE

(71) Applicant: Yanmar Co., Ltd., Osaka (JP)

(72) Inventors: Guillaume Multon, Saint-Dizier Cedex (FR); Christophe Caboret, Saint-Dizier Cedex (FR)

(21) Appl. No.: 14/223,840

(22) Filed: Mar. 24, 2014

(30) Foreign Application Priority Data
Apr. 11, 2013 (EP) 13305472.6

(51) Int. Cl. E02F 9/08; E05D 3/02

(52) U.S. Cl. CPC E02F 9/0891; E05D 3/02
USPC 16/221

(57) ABSTRACT

It is an object of the present invention to provide an attaching structure for a door of a working vehicle, by which the door is readily mounted. With respect to an attaching structure for a bonnet 51 rotatably held so as to block an opening portion 65 disposed in an engine compartment of a backhoe 100, the attaching structure includes the pivot holding member 53 that includes a pivot 52 configured to be provided in any one of the side of the bonnet 51 or the side of the backhoe 100 and configured to be the center of rotation of the bonnet 51, a shaft tube 531 configured to be provided in other one of the side of the bonnet 51 or the side of the backhoe 100 and configured to allow the pivot 52 to be inserted and rotatably hold the pivot 52, and a receiving portion 532 configured to support the pivot 52 when the pivot 52 is inserted into the shaft tube 531.

### CROSS-REFERENCE TO RELATED APPLICATIONS

The present application claims priority to European Patent Application No. 13305472.6, filed on Apr. 11, 2013, the disclosure of which is incorporated herein in its entirety by reference thereto.

### BACKGROUND OF THE INVENTION

1. Technical field

The present invention relates to a technology of an attaching structure for a door of a working vehicle.

2. Background Art

Conventionally, working vehicles include storage space to store apparatuses and the like. An opening portion used for maintenance of the apparatuses in the storage space is provided. A door to be blocked openably and closably is provided in the opening portion. For example, as is disclosed in Japanese Unexamined Patent Application Publication No. 2008-303714, a bonnet that openably and closably blocks the opening portion is provided in an engine compartment in which an engine is accommodated. The bonnet is rotatably attached to a rotation frame, which is disposed on the side of a working vehicle, with bolts and the like via a bonnet hinge made up of flat plate shaped members to be combined in advance.

However, it is not easy to install an object having a substantial weight, such as the bonnet, at an appropriate position by means of the bonnet hinge.

### BRIEF SUMMARY OF THE INVENTION

It is an object of the present invention to provide an attaching structure for a door of a working vehicle, by which the door is readily mounted.

The problems to be solved by the present invention have been described hereinabove, and subsequently, the means of solving the problems will be described below.

That is, one embodiment of the present invention, with respect to an attaching structure for a door rotatably held so as to block an opening portion disposed in an accommodation portion of a working vehicle, the attaching structure may include a pivot holding member that includes a pivot configured to be provided in any one of a side of the door or a side of the vehicle and configured to be a center of rotation of the door, a shaft tube configured to be provided in other one of the side of the door or the side of the vehicle and configured to allow the pivot to be inserted and rotatably hold the pivot, and a contact surface which is contacted with the pivot and is formed semicircular in side view so that it may extend from the side of the tube in which the pivot is inserted, a receiving portion configured to support the pivot by the contact surface when the pivot is inserted into the shaft tube.

According to one embodiment of the present invention, with respect to the attaching structure for the door of the working vehicle, the pivot holding member is provided in such a manner that a shaft center of the receiving portion concentrically corresponds to a shaft center of the shaft tube, and a plurality of pivots and pivot holding members are provided with respect to the door, and the receiving portions regarding the plurality of pivot holding members are provided in such a manner as to be directed in a same direction.

According to one embodiment of the present invention, with respect to the attaching structure for the door of the working vehicle, the pivot holding member includes a fixing portion in which a long hole is formed, and the fixing portion is adjustably provided in a longitudinal direction of the long hole.

According to one embodiment of the present invention, with respect to the attaching structure for the door of the working vehicle, the door includes a fixing side where the pivot or the pivot holding member is provided and an opening side disposed on a side opposite to the fixing side, and one on the side of the opening side is longer than a side of the fixing side.

### EFFECTS OF THE INVENTION

The embodiments of the present invention provide the following advantageous effects.

According to one embodiment of the present invention, the attaching structure for the door of the working vehicle includes the receiving portion. Accordingly, the pivot is supported by the receiving portion once, and the pivot can be inserted into the shaft tube, so that the door can readily be mounted on the working vehicle.

According to one embodiment of the present invention, the receiving portions regarding the plurality of pivot holding members are provided in such a manner as to be directed in the same direction. Accordingly, even in the case where the plurality of pivots and pivot holding members 53 are provided with respect to the one piece of door, the pivots are slid to the side of the shaft tube, thereby readily installing the bonnet on the working vehicle.

According to one embodiment of the present invention, the pivot holding member includes the fixing portion in which the long hole is formed, and the fixing portion is provided in the vicinity of the opening portion via a bracket. Accordingly, after the pivot is inserted into the shaft tube, the position of the door with respect to the working vehicle can finely be adjusted with ease within the range of the long hole.

According to one embodiment of the present invention, the door is formed in such a manner that the opening side thereof is longer that the fixing side thereof, thereby increasing the opening portion and improving the workability such as maintenance.

### BRIEF DESCRIPTION OF THE DRAWINGS

FIG. 1 is a diagram illustrating the entire configuration of a backhoe.

FIG. 2 is a rear view illustrating the backhoe.

FIG. 3 is a rear view illustrating the backhoe in which a bonnet is opened.

FIG. 4 is an exploded diagram illustrating components constituting the attaching structure of the bonnet.

FIG. 5 is a diagram illustrating a state where parts of an attaching structure 5 are attached.

FIG. 6 is a rear view illustrating a state before the bonnet is attached.

FIGS. 7A and 7B are rear diagrams illustrating a process of completing the attaching structure 5.

FIG. 8 is a plan view of a backhoe 100.

FIG. 9 is a plan view of a backhoe 101 according to other embodiment.

### DETAILED DESCRIPTION OF THE INVENTION

First, the entire configuration of a backhoe 100, which is a working vehicle, will be described. It is noted that the technological concept of the present invention is not limited to the backhoe 100 described below, but can generally be applied to working vehicles such as a construction equipment vehicle and an agricultural equipment vehicle.

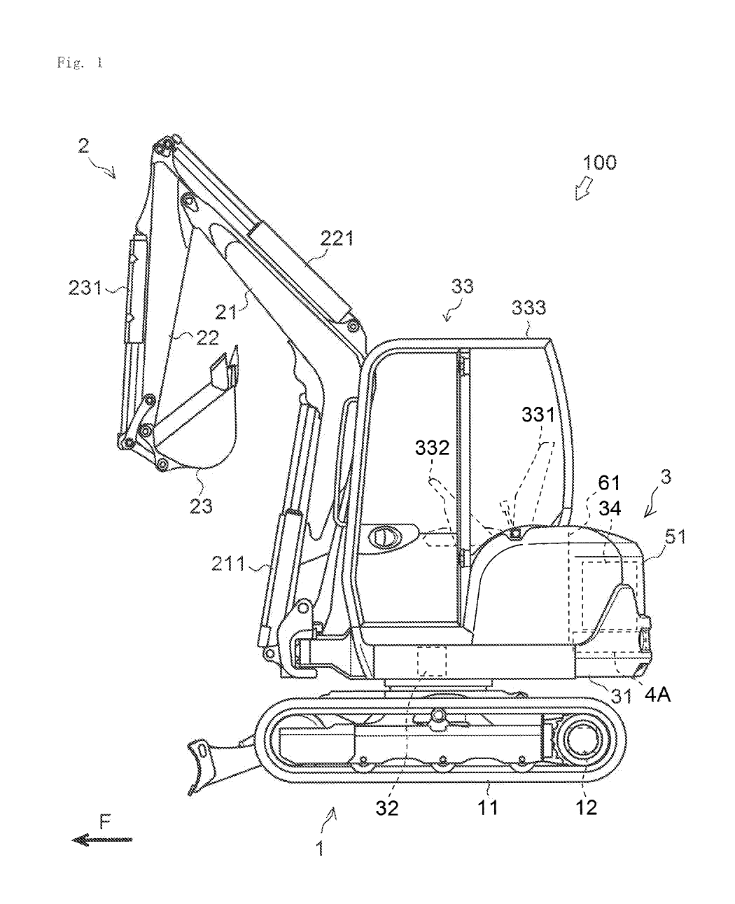

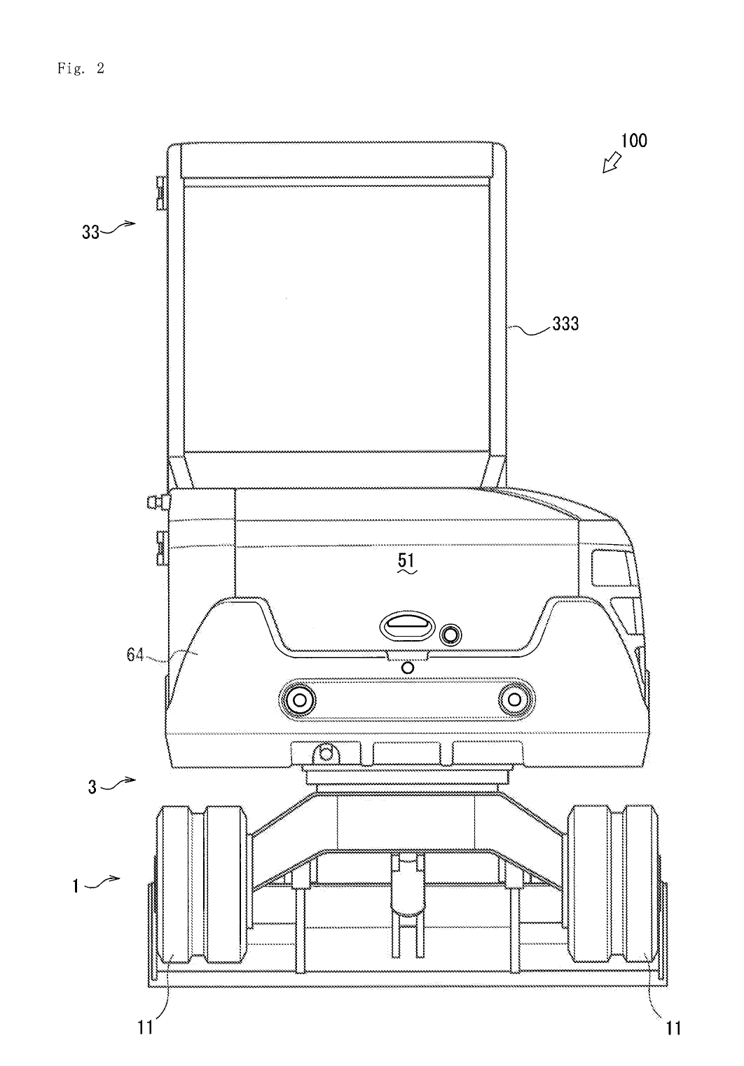

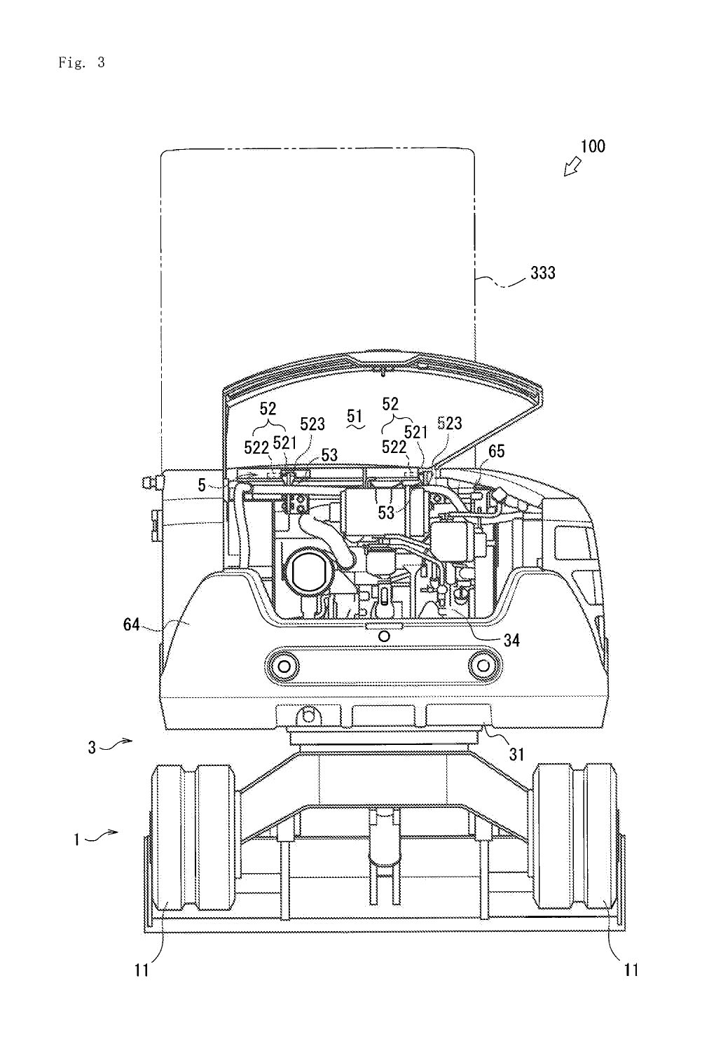

FIG. 1 is a diagram illustrating the entire configuration of the backhoe 100. FIG. 2 is a rear view of the backhoe 100. Then, FIG. 3 is a rear view of the backhoe 100 in which a bonnet 51 is opened. It is noted that an arrow F illustrated in the diagram represents the advancing direction of the backhoe 100.

As is illustrated in FIG. 1, the backhoe 100 is mainly constituted by a traveling apparatus 1, a working apparatus 2, and a rotation apparatus 3.

The traveling apparatus 1 allows the backhoe 100 to travel. The traveling apparatus 1 is constituted by a symmetrical pair of crawlers 11, a hydraulic motor 12, and the like. The traveling apparatus 1 allows the backhoe 100 to advance forward and backward by means of the left-and-right crawlers 11 driven by the hydraulic motor 12. Also, the traveling apparatus 1 allows the backhoe 100 to rotate by means of the left-and-right crawlers 11 independently driven by the hydraulic motor 12.

The working apparatus 2 is aimed at carrying out the operation of excavating earth and sand. The working apparatus 2 is constituted by a boom 21, an arm 22, a bucket 23, and the like. The working apparatus 2 drives these devices, which makes it possible to carry out the excavating operation.

To be more specific, the boom 21, whose one end portion is supported at the anterior portion of the rotation apparatus 3, is rotated by a movably retractable boom cylinder 211. Also, the arm 22, whose one end portion is supported by the other end portion of the boom 21, is rotated by a movably retractable arm cylinder 221. Then, the bucket 23, whose one end portion is supported by the other end portion of the arm 22, is rotated by a movably retractable bucket cylinder 231. That is, the working apparatus 2 has a multiple joint structure including rotating portions disposed at three locations. Thus, the working apparatus 2 drives these portions simultaneously or independently with each other, which makes it possible to carry out the excavating operation.

The rotation apparatus 3 is aimed at rotating the working apparatus 2. The rotation apparatus 3 is constituted by a rotation platform 31, a hydraulic motor 32, and the like. Regarding the rotation apparatus 3, the hydraulic motor 32 drives the rotation platform 31, which makes the working apparatus 2 rotatable. Also, an engine 34 is disposed in the rotation apparatus 3, in addition to an operating portion 33.

To be more specific, in the operating portion 33, an operating seat 331 and various operating devices 332 are provided. Then, the operating seat 331 and various operating devices 332 are covered by a cabin 333. An operator operates the operating devices 332 in a state where the operator stays seated at the operating seat 331 and carries out the control of the engine 34. Also, the operator operates the operating devices 332 and carries out the control of each of motors 12 and 32, and each of cylinders 211, 221, and 231. Thus, the operator operates the backhoe 100.

Further, as is illustrated in FIGS. 1 to 3, the engine 34 is supported via an engine supporting structure 4A at a rearward upper portion of the rotation apparatus 3. An engine compartment, which is an accommodation portion to accommodate the engine 34, is formed in such a manner that a low side surface thereof is enclosed by the rotation platform 31, and that a left-and-right-side surface and a front-side surface thereof are enclosed by a plurality of frames 61 that upwardly extend from the rotation platform 31, and that a rear-side surface thereof is enclosed by a bumper 64. Further, an opening portion 65 is formed from the rear portion to the upper portion of the engine compartment. The opening portion 65 is an opening used for maintenance of the engine 34 and the like in the engine compartment. The opening portion 65 is openably and closably covered by a bonnet 51, which is a door.

Hereinafter, the attaching structure 5 of the bonnet 51, which is a door according to the first embodiment of the present invention, will be described in detail.

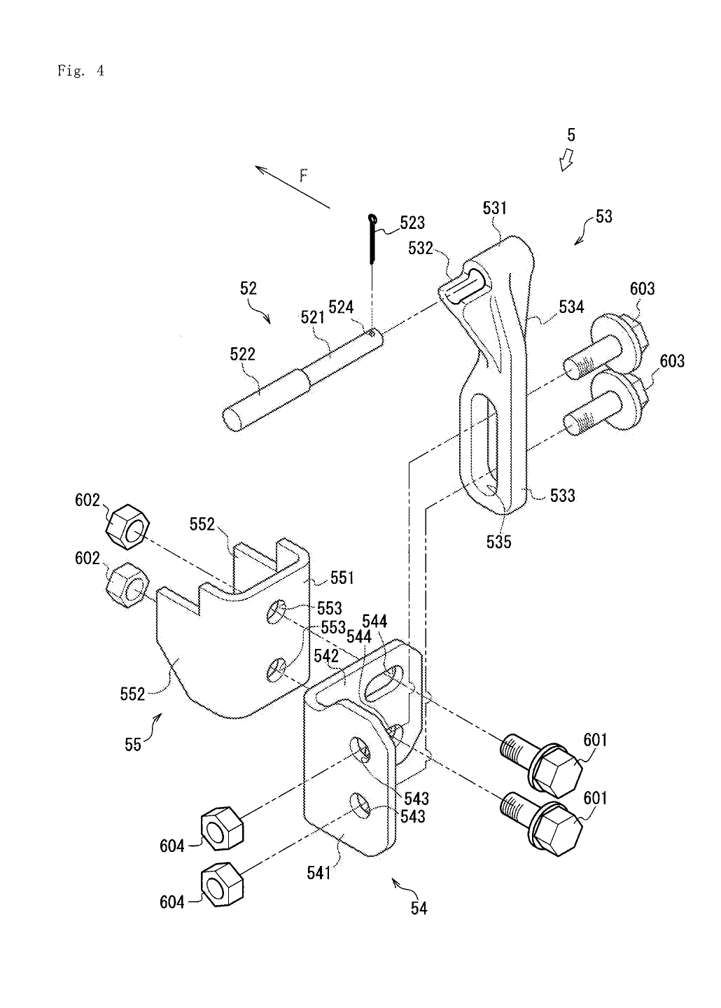

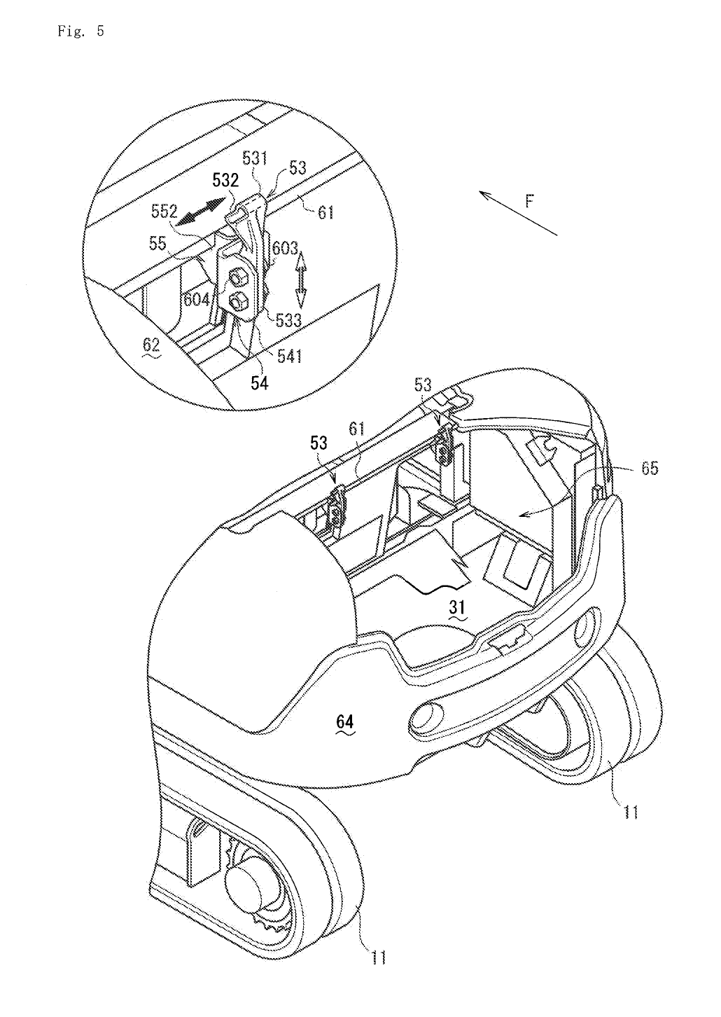

FIG. 4 is an exploded diagram illustrating components constituting the attaching structure 5 of the bonnet 51. FIG. 5 is a diagram illustrating a state where parts of the attaching structure 5 are attached. In the upper part of FIG. 5, an enlarged view of part of the attaching structure 5 of the bonnet 51 is illustrated. In order to facilitate easy understanding, FIG. 5 illustrates a state where the engine is not mounted in the engine compartment.

As is illustrated in FIGS. 3 to 5, the attaching structure 5 of the bonnet 51 is mainly constituted by a pivot 52 provided on the side of the bonnet 51, a pivot holding member 53 provided on the side of the working vehicle, that is, on a frame 61 constituting part of the engine compartment, and stays 54 and 55. It is noted that the attaching structure of the bonnet 51 may be such that the pivot holding member 53 and the stays 54 and 55 are provided on the side of the bonnet 51, and the pivot 52 is provided on the frame 61.

The pivot 52 serves as a pivot of the bonnet 51 and is provided on the inner side of a front end portion of the bonnet 51. The pivot 52 is a rod-shaped member that includes an inserting portion 521 and a fixing portion 522 and is extended in a left-and-right direction. The inserting portion 521 is smaller in diameter than the fixing portion 522 and formed in a cylindrical shape and serves as a portion that is inserted into the shaft tube 531 of the pivot holding member 53. The fixing portion 522 is a portion fixed by welding and the like to the bonnet 51. That is, regarding the pivot 52, the shaft tube 531 is insertably constituted based on the difference in diameter between the fixing portion 522 and the inserting portion 521. Further, a locking hole 524 into which a cotter pin 523 can be inserted is formed in the tip of the inserting portion 521.

Two pieces of pivots 52 are provided at two locations with a predetermined interval apart in the left-and-right direction with respect to the bonnet 51, and provided in such a manner that the inserting portions 521 are directed in the same direction.

The pivot holding member 53 is aimed at rotatably holding the pivot 52 attached to the bonnet 51. Also, the pivot holding member 53 is aimed at finely adjusting the position of the bonnet 51 in the up-and-down direction with respect to the backhoe 100. The pivot holding member 53 is mainly constituted by the shaft tube 531, a receiving portion 532, a fixing portion 533, and a connecting portion 534.

The shaft tube 531 is a portion into which the pivot 52 is inserted, so as to rotatably hold the pivot 52 to be inserted. The shaft tube 531 is a cylindrical portion that is open in the left-and-right direction.

The receiving portion 532 is a portion that receives the pivot 52 before being inserted into the shaft tube 531 and introduces the pivot 52 to the shaft tube 531. The receiving portion 532 is a portion that extends outwardly, from the side where the pivot 52 is inserted into the shaft tube 531, in the direction of the shaft center. Regarding the receiving portion 532, a semicircular contact surface is formed, when viewed from the side surface, in such a manner as to enclose the outer circumferential surface of the inserting portion 521 of the pivot 52. That is, the receiving portion 532 is provided in such a manner that the shaft center of the receiving portion 532 concentrically corresponds to that of the shaft tube 531.

The fixing portion 533 is a portion that fixes the pivot holding member 53 on the frame 61 via a first stay 54 and a second stay 55. A long hole 535 that can fix the pivot holding member 53 on the first stay 54 is formed in the fixing portion 533. The long hole 535 is open in the left-and-right direction in such a manner that the longitudinal direction thereof corresponds to the up-and-down direction.

The connecting portion 534 is a portion that connects the shaft tube 531, the receiving portion 532, and the fixing portion 533. The connecting portion 534 is formed in an inverted triangle when viewed from the front and formed in a shape in such a manner as to disperse loads, which are applied to the shaft tube 531 and the receiving portion 532, to the fixing portion 533.

The stay is constituted by the first stay 54 and the second stay 55. The first stay 54 supports the pivot holding member 53 and finely adjusts the position of the left-and-right direction in terms of the attaching structure 5 of the bonnet 51. The first stay 54 bends a plate member at an appropriate position in such a manner as to include a left side plate 541 and a front side plate 542 and is formed in an approximately L-shape when viewed from the plane. Attaching holes 543 that are open in the left-and-right direction are formed in the left side plate 541. The attaching holes 543 are formed at a predetermined interval apart in the up-and-down direction. A distance between the top end of the attaching hole 543 disposed upwardly and the low end end of the attaching hole 543 disposed downwardly is formed in such a manner as to be shorter than the length of the long hole 535 in the up-and-down direction. In the front side plate 542, attaching holes 544 to fix the first stay 54 on the second stay 55 are formed at a predetermined interval apart in the up-and-down direction. The longitudinal direction of the attaching holes 544 is the left-and-right direction.

The second stay 55 is aimed at fixing the pivot holding member 53 and the first stay 54 on the frame 61. The second stay 55 bends a plate member at an appropriate position in such a manner as to include a rear side plate 551 and left-side and right-side plates 552 and is formed in an approximately U-shape, whose anterior portion is open, when viewed from the plane. The upper surface of the left-side and right-side plates 552 is formed in such a manner that the upper surface is disposed lower than the rear side plate 551 so as to readily be brought into contact with the frame 61. In the rear side plate 511, attaching holes 553 that are open in the forward-and-backward direction are formed at a predetermined interval apart in the up-and-down direction. Also, the attaching holes 553 are formed at position corresponding to the attaching holes 544 of the first stay 54.

Next, the process of attaching the pivot holding member 53 to the frame 61 of the backhoe 100 will be described.

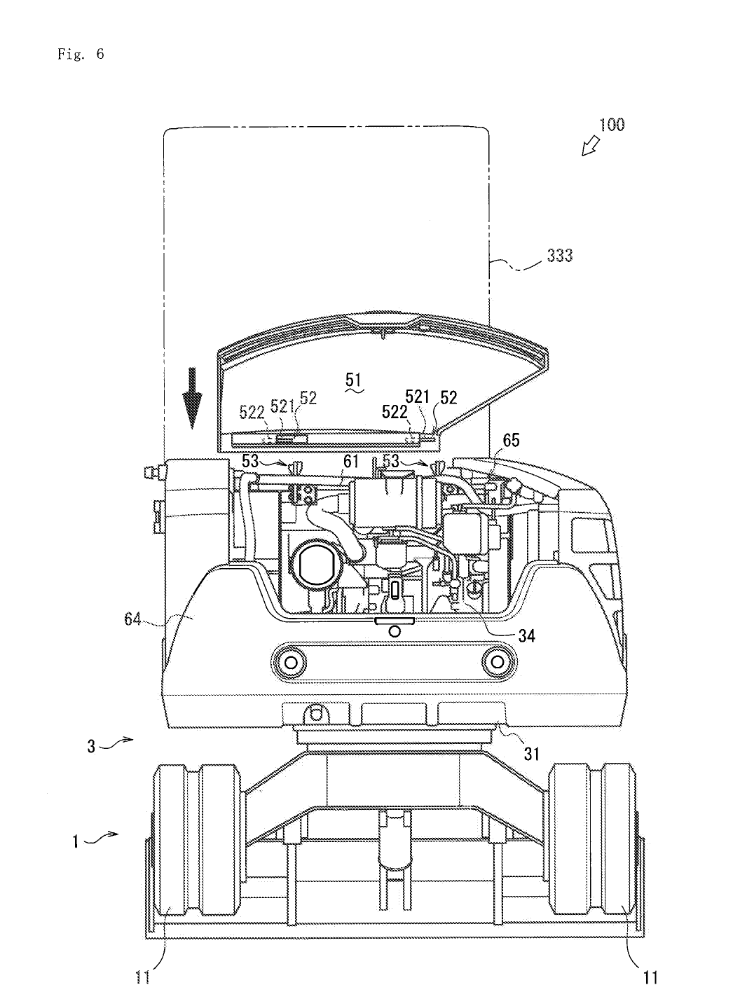

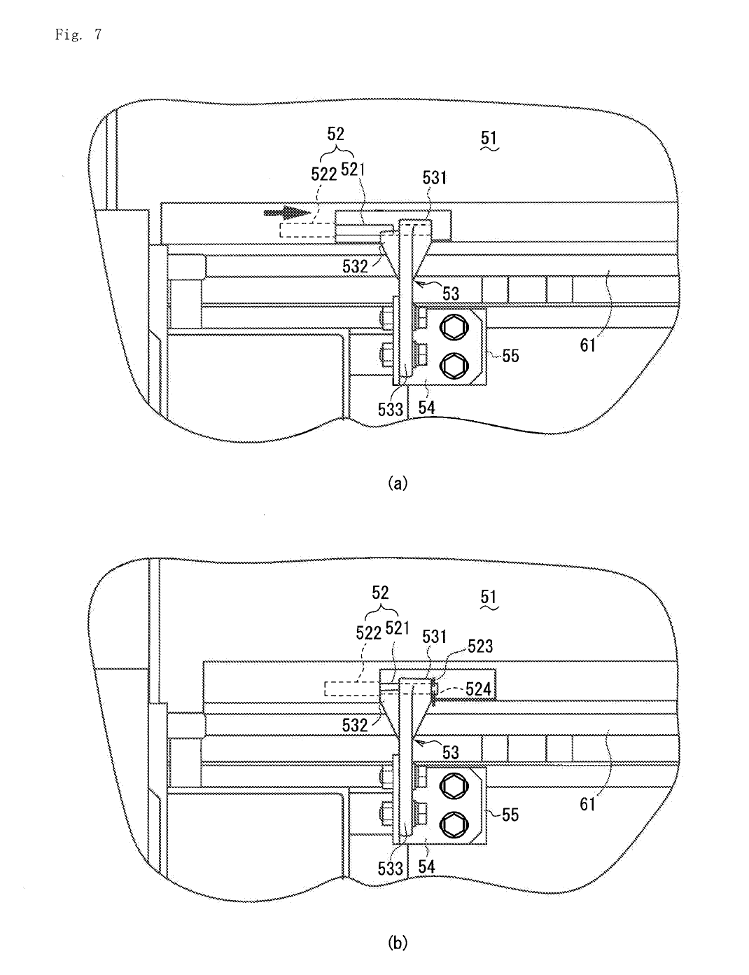

FIG. 6 is a rear view illustrating a state before the bonnet 51 is attached. FIG. 7 is a rear diagram illustrating a process of completing the attaching structure 5.

First, as is illustrated in FIG. 5 which represents the components illustrated in FIG. 4, the second stays 55 are fixed by welding and the like at positions corresponding to the pivots 52 with respect to the frame 61. The first stay 54 is attached to the second stay 55. While the attaching holes 544 of the first stay 54 and the attaching holes 553 of the second stay 55 are fitted with each other, bolts 601 are inserted into the first stay 54, which is fixed with nuts 602, whereby the first stay 54 is attached to the second stay 55.

Further, the pivot holding member 53 is fixed on the first stay 54. That is, while the long hole 535 of the fixing portion 533 of the pivot holding member 53 is fitted with the attaching holes 543 provided in the left side plate 541 of the first stay 54, bolts 603 are inserted into the pivot holding member 53, which is fixed with nuts 604, whereby the pivot holding member 53 is attached to the first stay 54. In this state, the pivot holding member 53 illustrated in FIG. 5 is attached to the frame 61.

Next, the pivots 52 are disposed with respect to the pivot holding members 53. As is illustrated in FIG. 6, the pivots 52 attached to the bonnet 51 are in a state where the pivots 52 are separated from the pivot holding members 53. As is illustrated FIG. 7A from a state represented in FIG. 6, the bonnet 51 is downwardly transferred in such a manner that the outer circumferential surface of the inserting portion 521 of the pivot 52 is brought into contact with the receiving portion 532 of the pivot holding member 53 (see a thick arrow in FIG. 6). Further, the pivot 52 along with the bonnet 51 is transferred in the direction of the thick arrow, that is, on the side of the shaft tube 531 in such a manner as to change from the state illustrated in FIG. 7A to the state illustrated in FIG. 7B. In this case, the receiving portion 532 and the shaft tube 531 are provided in such a manner that the shaft center of the receiving portion 532 concentrically corresponds to that of the shaft tube 531. Further, a portion where the receiving portion 532 and the inserting portion 521 of the shaft tube 531 come in contact with each other is smoothly formed without a difference, so that the inserting portion 521 can be inserted in to the shaft tube 531 without difficulty.

That is, the pivot 52 is brought into contact with the receiving portion 532 once, so that the load of the bonnet 51 can be supported on the side of the pivot holding members 53 via the pivot 52. The balance of the load of the bonnet 51 can be stabilized before the pivot 52 is inserted into the shaft tube 531. Then, the pivot 52 can be inserted into the shaft tube 531 only by transferring the entire bonnet 51 in the horizontal direction, that is, by transferring the bonnet 51 in the left-and-right direction. Accordingly, the pivot 52 can readily be transferred to an appropriate position, even if the bonnet 51 having a heavy load is transferred.

When the inserting portion 521 of the pivot 52 is inserted into an appropriate position of the shaft tube 531 of the pivot holding member 53, the cotter pin 523 is inserted into the locking hole 524 of the inserting portion 521. Accordingly, it is less likely that the pivot 52 comes off the pivot holding member 53.

Thus, even in the case where a plurality of pivot holding members 53 are provided with respect to the one piece of bonnet 51, the position of the receiving portion 532 is provided in the same direction with regards to the shaft tube 531, so that the inserting portion 521 can be inserted into the shaft tube 531 by sliding the bonnet 51.

Also, the long hole 535 is formed in the pivot holding member 53, so that the pivot holding member 53 can be transferred in the up-and-down direction by loosening the bolts 603 in a state where the bonnet 51 is separately supported (see an arrow in white in FIG. 5 in the longitudinal direction of the long hole). Thus, the pivot holding member 53 is transferred above, so that the fixing position in the up-and-down direction of the bonnet 51 with respect to the working vehicle can finely be adjusted.

Also, the attaching holes 544, which are a long hole, are formed in the first stay 54, so that the first stay 54 along with the pivot holding member 53 can be transferred in the left-and-right direction by loosening the bolts 601 in a state where the bonnet 51 is suspended and separately supported (see the thick arrow in FIG. 5 in the longitudinal direction of the attaching holes 544). Thus, the pivot holding member 53 is transferred above, so that the fixing position in the left-and-right direction of the bonnet 51 with respect to the working vehicle can finely be adjusted.

With respect to an attaching structure for a door (bonnet 51) rotatably held so as to block an opening portion 65 disposed in an accommodation portion (engine compartment) of a working vehicle (backhoe 100), the attaching structure includes the pivot holding member 53 that includes a pivot 52 configured to be provided in any one of the side of the bonnet 51 or the side of the backhoe 100 and configured to be the center of rotation of the bonnet 51, a shaft tube 531 configured to be provided in other one of the side of the bonnet 51 or the side of the backhoe 100 and configured to allow the pivot 52 to be inserted and rotatably hold the pivot 52, and a receiving portion 532 configured to support the pivot 52 when the pivot 52 is inserted into the shaft tube 531.

Based on this structure, the pivot 52 is supported by the receiving portion 532 once, and the pivot 52 can be inserted into the shaft tube 531, so that the bonnet 51, which is the door, can readily be mounted on the backhoe 100, which is a working vehicle.

Also, a plurality of pivots 52 and pivot holding members 53 are provided with respect to the bonnet 51, and the receiving portions 532 regarding the plurality of pivot holding members 53 are provided in such a manner as to be directed in the same direction. Also, the pivot holding member 53 is provided in such a manner that the shaft center of the receiving portion 532 concentrically corresponds to the shaft center of the shaft tube 531, and the plurality of pivots 52 and pivot holding members 53 are provided with respect to the bonnet 51, which is the door, and the receiving portions 532 regarding the plurality of pivot holding members 53 are provided in such a manner as to be directed in the same direction.

Based on this structure, even in the case where the plurality of pivots 52 and pivot holding members 53 are provided with respect to the one piece of bonnet 51, the pivots 52 are slid to the side of the shaft tube 531, thereby readily arranging the bonnet 51 on the side of a working device.

Also, the pivot holding member 53 includes the fixing portion 533 in which a long hole 535 is formed, and the fixing portion 533 is adjustably provided in the longitudinal direction of the long hole 535.

Based on this structure, after the pivot 52 is inserted into the shaft tube 531, the position of the bonnet 51 with respect to the backhoe 100 can finely be adjusted with ease within the range of the long hole 535.

Hereinafter, the bonnets 51 and 151 using the attaching structure 5 will be described.

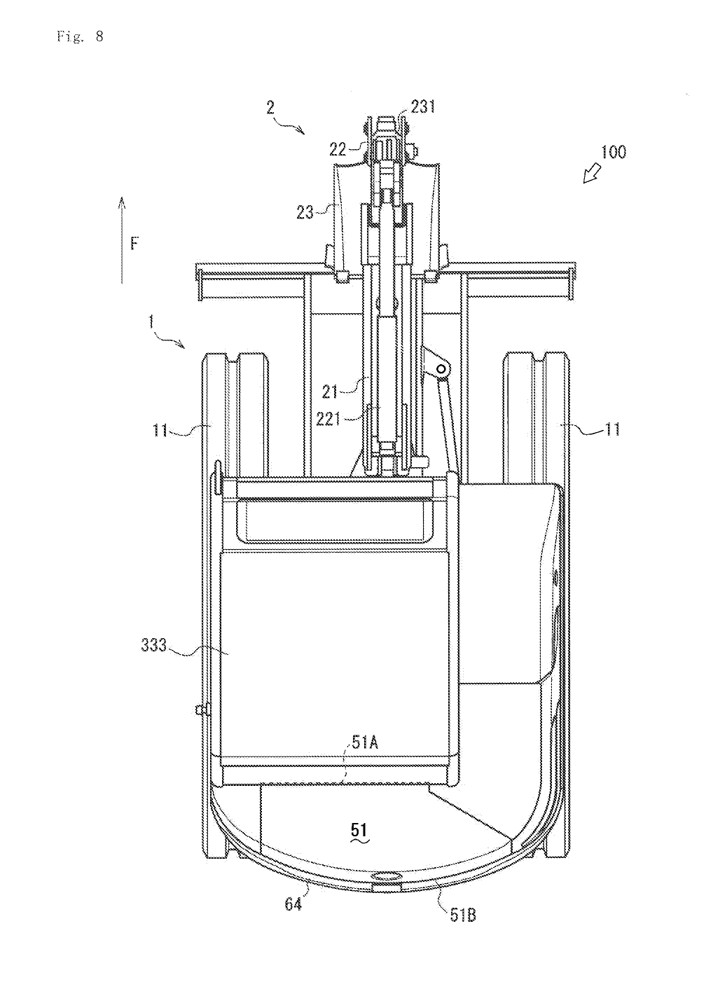

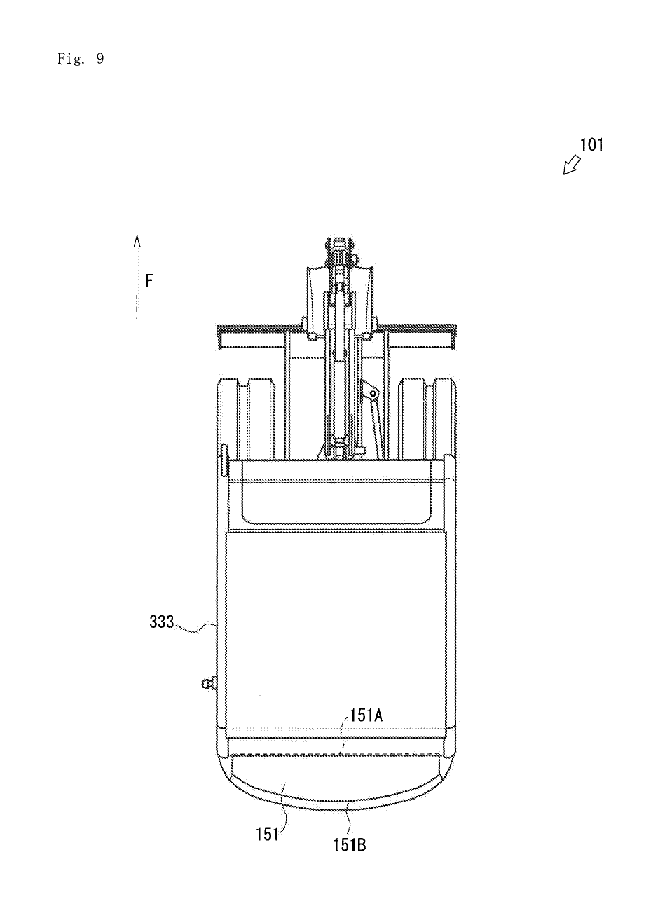

FIG. 8 is a plan view of the backhoe 100. FIG. 9 is a plan view of a backhoe 101 according to other embodiment. It is noted that FIGS. 8 and 9 illustrate the backhoes 100 and 101 in which the same cabin 333 is mounted.

As is illustrated in FIG. 8, the bonnet 51 described above is such that the anterior side, where the pivot 52 is provided, is a fixing side 51A to be fixed on the side of the body thereof, and the posterior side, that is, the side opposite to the fixing side 51A is an opening side 51B. The bonnet 51 is formed in such a manner that the length in the vehicle width direction, that is, the left-and-right direction is extended in closer proximity to the opening side 51B from the fixing side 51A. Further, the fixing side 51A of the bonnet 51 falls within the length of the left-and-right direction of the cabin 333. The cabin 333 is not disposed in the center of the backhoe 100 in terms of the left-and-right direction, but is shifted in one direction out of the left and right directions, that is, in the left direction. Accordingly, the bonnet 51 is formed in such a manner as to protrude in the other direction out of the left and right directions, that is, the right direction, when viewed from the plane. This is aimed at increasing the opening portion 65 of the engine compartment where the engine 34 is accommodated as much as possible and improving the work efficiency such as maintenance.

As for the backhoe 101 illustrated in FIG. 9 according to other embodiment, the bonnet 151 is such that the anterior side where the pivot 52 is provided is a fixing side 151A to be fixed on the side of the body thereof, and further, the posterior side, that is, the side opposite to the fixing side 151A is an opening side 151B. The bonnet 151 has an approximately constant length in the vehicle width direction, that is, in the left-and-right direction, from the fixing side 151A to the opening side 151B.

That is, even when the same cabin 333 is used that determines the length of the left-and-right direction of the fixing sides 51A and 151A, the bonnet 51 can substantially broaden the opening portion 65 of the engine compartment, compared with the bonnet 151. Regarding the bonnet 51, the center of gravity is shifted to the right side, compared with the bonnet 151. However, according to the attaching structure 5 of the bonnet 51, the positions of the bonnet 51 in the up-and-down direction and the left-and-right direction can finely be adjusted, so that the bonnet 51 can be attached in a steady state.

The bonnet 51, which is the door, includes the fixing side 51A where the pivot 52 and the pivot holding member 53 are provided and the opening side 51B disposed on the side opposite to the fixing side 51A, and wherein one side of the opening side 51B is longer than the side of the fixing side 51A.

This structure can increase the opening portion 65, thereby improving the workability such as maintenance.

### DESCRIPTION OF THE REFERENCE NUMERAL

100 Backhoe (Working vehicle)
51 Bonnet (Door)
51A Fixing side
51B Opening side
52 Pivot
53 Pivot holding member
531 Shaft tube
532 Receiving portion
533 Fixing portion
535 Long hole
65 Opening portion

1. An attaching structure for a door rotatably held so as to block an opening portion disposed in an accommodation portion of a working vehicle, the attaching structure comprising:
a pivot holding member, including:
a pivot configured to be provided in any one of a side of the door or a side of the vehicle and configured to be a center of rotation of the door;
a shaft tube configured to be provided in other one of the side of the door or the side of the vehicle and configured to allow the pivot to be inserted and rotatably hold the pivot; and
a contact surface which is contacted with the pivot and is formed semicircular in side view so that it may extend from the side of the tube in which the pivot is inserted, a receiving portion configured to support the pivot by the contact surface when the pivot is inserted into the shaft tube.

2. The attaching structure for the door of the working vehicle according to claim 1,
wherein the pivot holding member is provided in such a manner that a shaft center of the receiving portion concentrically corresponds to a shaft center of the shaft tube, and
a plurality of pivots and pivot holding members are provided with respect to the door, and the receiving portions regarding the plurality of pivot holding members are provided in such a manner as to be directed in a same direction.

3. The attaching structure for the door of the working vehicle according to claim 1,
wherein the pivot holding member includes a fixing portion in which a long hole is formed, and
the fixing portion is adjustably provided in a longitudinal direction of the long hole.

4. The attaching structure for the door of the working vehicle according to claim 1,
wherein the door includes a fixing side where the pivot or the pivot holding member is provided and an opening side disposed on a side opposite to the fixing side, and
wherein one side of the opening side is longer than a side of the fixing side.

5. The attaching structure for the door of the working vehicle according to claim 2,
wherein the pivot holding member includes a fixing portion in which a long hole is formed, and
the fixing portion is adjustably provided in a longitudinal direction of the long hole.

6. The attaching structure for the door of the working vehicle according to claim 2,
wherein the door includes a fixing side where the pivot or the pivot holding member is provided and an opening side disposed on a side opposite to the fixing side, and
wherein one side of the opening side is longer than a side of the fixing side.

7. The attaching structure for the door of the working vehicle according to claim 3,
wherein the door includes a fixing side where the pivot or the pivot holding member is provided and an opening side disposed on a side opposite to the fixing side, and
wherein one side of the opening side is longer than a side of the fixing side.
